(19) United States
(12) Patent Application Publication
(10) Pub. No.: US 2011/0235229 A1
(43) Pub. Date: Sep. 29, 2011

(54) ETHERNET SURGE PROTECTOR

(76) Inventors: Eric H. Nguyen, Hayden, ID (US); Trevor Tollefsbol, Hayden, ID (US)

(21) Appl. No.: 13/069,699

(22) Filed: Mar. 23, 2011

Related U.S. Application Data
(60) Provisional application No. 61/317,979, filed on Mar. 26, 2010.

(51) Int. Cl. H02H 3/22

(52) U.S. Cl. 361/119

(57) ABSTRACT

An Ethernet surge protector can be mounted externally and/or internally to a wall of a building. The Ethernet surge protection device may include a housing, a threaded port, and a surge filter. The housing may define a space along an axis. The threaded port may be configured to be coupled to the housing, and it may have a locking surface that may be configured to prevent the housing from rotating about the axis upon engaging a mounting fixture. The surge filter may be disposed within the space, and it may be configured to filter out a surge component of an Ethernet signal received from an input cable.

### CLAIM OF PRIORITY UNDER 35 U.S.C. §119(e)

This application claims priority to and the benefit of U.S. Provisional Application No. 61/317,979, entitled “ETHERNET SURGE PROTECTOR,” filed on Mar. 26, 2010, which is assigned to the assignee hereof and hereby expressly incorporated by reference herein.

### BACKGROUND

1. Field

The present invention generally relates to the field of surge protectors, and more particularly to the field of Ethernet surge protectors.

2. Description of the Related Art

Surge protection is the process of protecting electronic systems or equipment from voltages and currents which are outside their safe operating limits. Surge voltages and surge currents can be generated by short circuits, lightning or faults from a power system, and they may enter the electronic system along inter-equipment wiring. As in the case of a lightning strike, for example, the surges may be galvanically coupled into the electronic system through an inadvertent connection of the power system to the wiring. In another example, the surges may be capacitively coupled into the electronic system that is in the vicinity of a high voltage power line. In another example, the surges may be inductively coupled into the electronic system if the electronic wiring is run in parallel with a power circuit.

Surge protection devices may be used for protecting electronic systems or equipment from surges. Specifically, Ethernet surge protection device may protect Ethernet interface devices that are used in a computer system and/or a server system. Conventional Ethernet surge protection devices are not mounted to a wall of a building because they lack mounting components for fitting into a standard bulkhead panel. As such, conventional Ethernet surge protection devices are installed adjacent to the Ethernet interface devices, which are generally located inside a building.

The Ethernet surge protection devices may receive maintenance service from time to time. Because conventional Ethernet surge protection devices are not mounted at any exterior wall, it may be difficult for the maintenance staff to render maintenance service without gaining access to the building. Moreover, conventional Ethernet surge protection devices may be hard to organize because they are not centrally mounted at a particular location. A user of conventional Ethernet surge protection devices may build a custom rack for mounting several conventional Ethernet surge protection devices. However, the cost for building a custom rack may be high, and the custom rack may or may not be suitable for other types of surge protection devices, such as a radio frequency (RF) surge protection device.

Thus, there is a need for an Ethernet surge protector with improved mounting functionalities.

### SUMMARY

The present invention may provide an Ethernet surge protector (a.k.a. “Ethernet surge protection device”) that can be mounted to a standard bulkhead mount. Because the standard bulkhead mount may be preinstalled at one of the exterior walls of a building, a user of the Ethernet surge protector may use the standard bulkhead mount as a mounting fixture without having to build a custom rack. Moreover, the Ethernet surge protector may be mounted externally and/or internally, such that the user of the Ethernet surge protector may preserve the option of servicing the Ethernet surge protector outside and/or inside the building.

In one embodiment, the present invention may provide an Ethernet surge protection (ESP) device, which may include a housing defining a space along an axis, a threaded port configured to be coupled to the housing, and having a locking surface configured to prevent the housing from rotating about the axis upon engaging a mounting fixture, and a surge filter disposed within the space, and configured to filter out a surge component of an Ethernet signal received from an input cable.

In another embodiment, the present invention may provide an Ethernet surge protection (ESP) device, which may include a housing defining a cavity along an axis, a plurality of threaded mounts, each of the plurality of threaded mounts detachably coupled to the housing, and having a locking surface configured to prevent the housing from rotating about the axis upon engaging a mounting fixture, the plurality of threaded mounts including an input threaded mount and an output threaded mount, and a surge suppressor disposed within the cavity, the surge suppressor configured to suppress a surge component from an Ethernet signal received via the input threaded mount and deliver the surge suppressed Ethernet signal via the output threaded mount.

In yet another embodiment, the present invention may provide an Ethernet surge protection (ESP) device, which may include a housing defining a compartment along an axis, a bulkhead mount configured to be coupled to the housing, and having a D-shaped cross-section perpendicular to the axis, the D-shaped cross-section including a threaded arc segment and a cord segment connecting the threaded arc segment, the threaded arc segment configured to receive a nut for securing the housing to a mounting fixture, the cord segment configured to cooperate with the mounting fixture to prevent the housing from rotating about the axis, and a surge filter disposed within the compartment, and configured to filter out a surge component of an Ethernet signal received from an input cable.

This summary is provided merely to introduce certain concepts and not to identify any key or essential features of the claimed subject matter.

### BRIEF DESCRIPTION OF THE DRAWINGS

Other systems, methods, features, and advantages of the present invention will be or will become apparent to one skilled in the art upon examination of the following figures and detailed description. It is intended that all such additional systems, methods, features, and advantages be included within this description, be within the scope of the present invention, and be protected by the accompanying claims. Component parts shown in the drawings are not necessarily to scale, and may be exaggerated to better illustrate the important features of the present invention. In the drawings, like reference numerals designate like parts throughout the different views, wherein:

FIG. 1A shows a building with an internally mounted Ethernet surge protection (ESP) device and an externally mounted ESP device according to an embodiment of the present invention;

FIG. 1B shows a cross-sectional view of a mounting fixture mounted by the internally mounted ESP device and the externally mounted ESP device according to an embodiment of the present invention;

FIG. 2A shows an exploded cross-sectional view of an ESP device and an Ethernet cable with an Ethernet connector according to an embodiment of the present invention;

FIG. 2B shows an exploded perspective view of the ESP device and a segment of the mounting fixture according to an embodiment of the invention;

FIG. 3 shows an exploded perspective view of an ESP core member according to an embodiment of the present invention;

FIGS. 4A-4E show various dimensions of a bulkhead mount according to various embodiments of the present invention;

FIGS. 5A-5C show the front views of various mounting ports according to various embodiments of the present invention;

FIG. 6A shows a perspective view of a surge filter according to an embodiment of the present invention;

FIG. 6B shows a top view of a PCB with various surge suppressing components according to an embodiment of the present invention;

FIG. 7 shows a schematic view of a surge filter for a high speed Ethernet signal according to an embodiment of the present invention;

FIG. 8 shows a schematic view of a surge filter for a high speed Ethernet signal with power transmission according to an embodiment of the present invention;

FIG. 9 shows a schematic view of a surge filter for a POE signal according to an embodiment of the present invention; and

FIG. 10 shows a cross-sectional view of a coplanar waveguide printed circuit board according to an embodiment of the present invention.

### DETAILED DESCRIPTION

Apparatus, systems and methods that implement the embodiment of the various features of the present invention will now be described with reference to the drawings. The drawings and the associated descriptions are provided to illustrate some embodiments of the present invention and not to limit the scope of the present invention. Throughout the drawings, reference numbers are re-used to indicate correspondence between reference elements. In addition, the first digit of each reference number indicates the figure in which the element first appears.

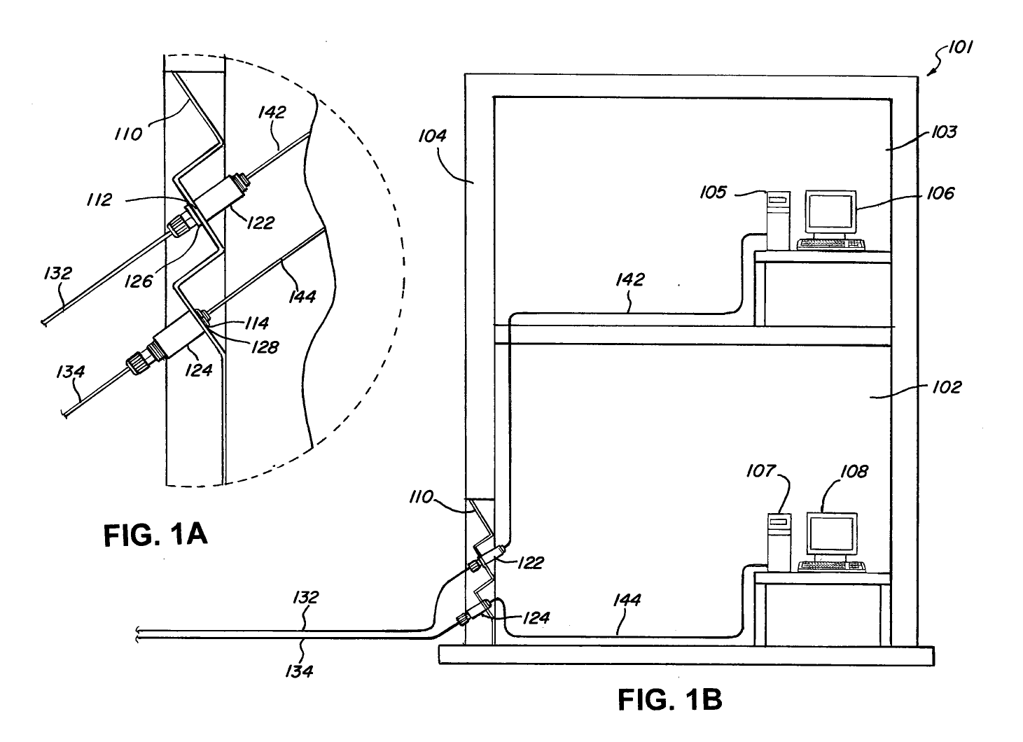

FIG. 1A shows a building 101 with an internally mounted Ethernet surge protection (ESP) device 122 and an externally mounted ESP device 124 according to an embodiment of the present invention. The building 101 may be a commercial and/or residential building having one or more floors, such as a first floor 102 and a second floor 103. The second floor 103 may be equipped with a first Ethernet enabled computer 105, which may be used in conjunction with a first monitor 106. The first floor 102 may be equipped with a second Ethernet enabled computer 107, which may be used in conjunction with a second monitor 108.

The first and second Ethernet enabled computers 105 and 107 may be connected to one or more computer networks via one or more Ethernet cables. For example, the first Ethernet enabled computer 105 may be connected to a first protected Ethernet cable 142, the internally mounted ESP device 122, and a first unprotected Ethernet cable 132. Similarly, the second Ethernet enabled computer 107 may be connected to a second protected Ethernet cable 144, the externally mounted ESP device 124, and a second unprotected Ethernet cable 134.

The first and second unprotected Ethernet cables 132 and 134 may be disposed outside the building 101. The first and second unprotected Ethernet cables 132 and 134 may each conduct an Ethernet signal. The voltage and current of the Ethernet signal may be affected by several external conditions, such as lightning, power line interference, and/or earth potential rise. Generally, these external conditions may introduce a surge component to the Ethernet signal. The surge component may include a surge voltage and/or a surge current.

Excessive surge voltage and/or surge current may cause damage to the Ethernet interface devices (not shown) of the first Ethernet enabled computer 105 and the second Ethernet enabled computer 107. To protect the Ethernet interface devices from surge voltage and/or surge current, an ESP device (e.g., the internally mounted ESP device 122 and the externally mounted ESP device 124) may be used for suppressing and/or filtering out the surge component of the Ethernet signal. The ESP device may output the filtered or surge suppressed Ethernet signals to one or more protected Ethernet cables, such as the first protected Ethernet cable 142 and the second protected Ethernet cable 144. Consequently, the filtered or surge suppressed Ethernet signals may be delivered to the first Ethernet enabled computer 105 and the second Ethernet enabled computer 107.

The ESP device may be mounted inside the building 101. More preferably, the ESP device may be mounted to a wall 104 of the building 101. The wall 104 may be an exterior wall, which may be installed with a mounting fixture 110. The mounting fixture 110 may include one or more panels for holding the ESP devices. Additionally, the mounting fixture 110 may be used for holding one or more radio frequency (RF) signal surge protection devices. The mounting fixture 110 may have a zigzag shape as shown in FIG. 1. Alternatively, the mounting fixture 110 may be a straight, flat plate.

The mounting fixture 110 may be a bulkhead panel, which may include one or more mounting apertures that comports with the industrial M29 DIN standard. The bulkhead panel may be preinstalled in the building 101 for holding various types of surge protection devices. In one embodiment, the ESP device may have a mounting port with a cross-section that can fit well within the mounting aperture of the bulkhead panel. As such, a user may conveniently mount the ESP device to the preinstalled bulkhead panel without having to build a separate mounting fixture inside the building 101.

From a surge protection standpoint, mounting the ESP device to the wall 104 may be advantageous over mounting the ESP device to a location that is close by the computer (e.g., the first or second Ethernet enabled computer 105 or 107). When the ESP device is mounted to the wall 104 via the mounting fixture 104, the distance between the ESP device and the computer may increase. As such, the length of the protected Ethernet cable (e.g., the first and second protected Ethernet cables 142 and 144) may be prolonged. The protected Ethernet cable may therefore incur additional impedance for reducing the residual surge component of the Ethernet signal. Moreover, the ESP devices may be easy to handle, maintain and organize when they are mounted at a centralized location.

As illustrated in FIG. 1B, the ESP device can be mounted internally and/or externally. It is desirable to mount the ESP device internally when the ESP device is serviced by an in-house technician that has access to the building 101. The internally mounted ESP device 122 may have an input mounting port 126 that fits well into a first mounting aperture 112 of the mounting fixture 110 according to an embodiment of the present invention. The first mounting aperture 112 may be a standard M29 single-D hole or a standard M29 double-D hole. When properly mounted, the core member of the internally mounted ESP device 122 may be accessed from the inside of the building 101. Advantageously, the in-house technician may repair and/or replace components of the ESP device without leaving the building 101.

On the other hand, it is desirable to mount the ESP device externally when the ESP device is serviced by a third party vendor that does not have access to the building 101. The externally mounted ESP device 124 may have an output mounting port 128 that fits well into the second mounting aperture 114 of the mounting fixture 110 according to another embodiment of the present invention. The second mounting aperture 114 may be a standard M29 single-D hole or a standard M29 double-D hole. When properly mounted, the core member of the externally mounted ESP device 124 may be accessed from the outside of the building 101. Advantageously, the third party vendor may repair and/or replace components of the ESP device without entering the building 101.

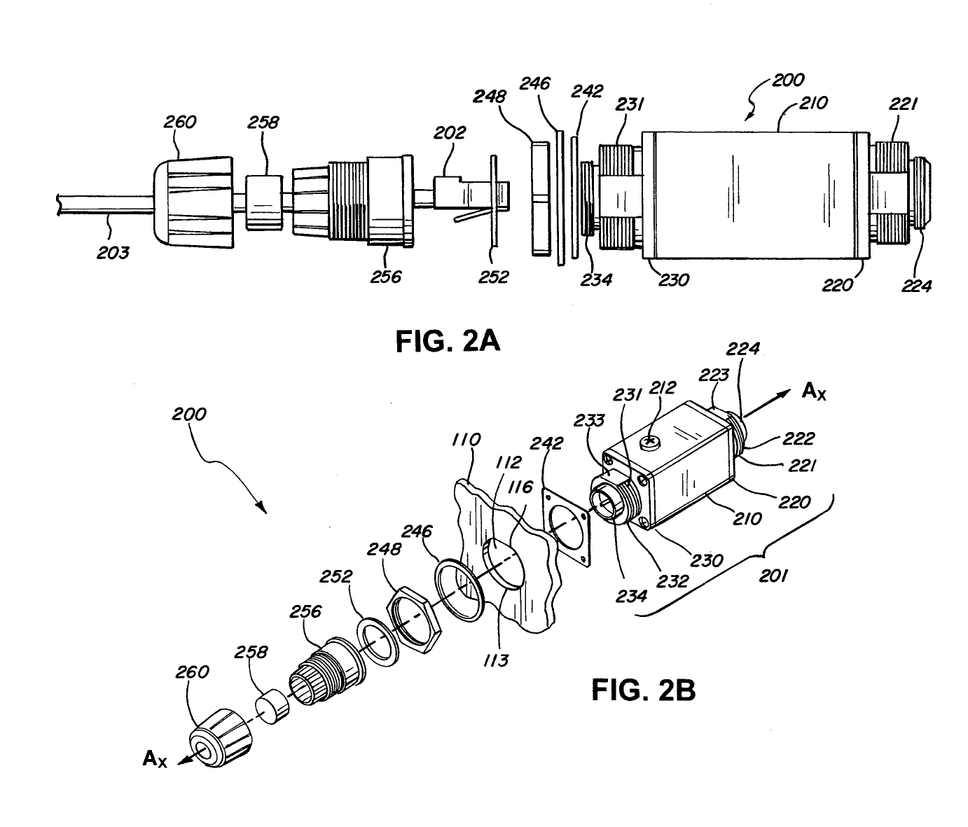

FIG. 2A shows an exploded cross-sectional view of an ESP device 200 and an Ethernet cable 203 with an Ethernet connector 202 according to an embodiment of the present invention. The ESP device 200 may be adaptively used as the internally mounted ESP device 122 and/or the externally mounted ESP device 124 as shown in FIGS. 1A and 1B. Generally, the ESP device 200 may include a housing 210, an output mount 220, and an input mount 230. The housing 210 may define a space, a cavity, and/or a compartment for storing surge suppressing components. The housing 210 may have a first open end and a second open end opposing the first open end. The first and second open ends may define a common axis A_{X}. In one embodiment, the housing 210 may have a rectangular shape. In another embodiment, the housing 210 may have a cylindrical shape.

The output mount 220 may be detachably connected to a first end of the housing 210, while the input mount 230 may be detachably connected to a second end of the housing 230. When the ESP device 200 is mounted externally, the output mount 220 may include an output mounting port 221, while the input mount 230 may or may not include an input mounting port 231. When the ESP device 200 is mounted internally, the input mount 230 may include the input mounting port 231, while the output mount 220 may or may not include the output mounting port 221. Preferably, regardless of whether the ESP device 200 is mounted externally or internally, the input mount 230 may include the input mounting port 231, and the output mount 220 may include the output mounting port 221. The housing 210, the output mount 220, and the input mount 230 may be combined to form an ESP core member 201.

Referring to FIG. 2B, which shows an exploded perspective view of the ESP device 200 and a segment of the mounting fixture 110, the output mounting port 221 and the input mounting port 231 may include additional features. The input mounting port 231 may have a partially cylindrical surface 232 and a locking surface 233. The partially cylindrically surface 232 may be threaded, and it may be connected to the locking surface 233 to form a tube that has a D-shape cross-section.

The input mounting port 231 may serve at least two functions when the ESP device 200 is mounted internally. First, the input mounting port 231 may be used for receiving and protecting an Ethernet connector 202 and a portion of the Ethernet cable 203, which may or may not be surge protected. Second, the input mounting port 231 may provide a mounting point such that the ESP device 200 may be mounted to the mounting fixture 110. Particularly, the D-shape cross-section of the input mounting port 231 may match the shape of the first mounting aperture 112, so that the input mounting port 231 may penetrate the first mounting aperture 112.

The partially cylindrical surface 232 may have a similar curvature as an arc segment 113 of the first mounting aperture 112. After the input mounting port 231 is inserted through the first mounting aperture 112, the locking surface 233 may align with a cord segment 116 of the first mounting aperture 112. The locking surface 233 may be a flat surface, and it may cooperate with the cord segment 116 for preventing the housing 210 from rotating about the common axis A_{X}.

In one embodiment, the ESP device 200 may include a bulkhead gasket 242, a washer 246, a panel nut 248, a connector shroud gasket 252, a connector shroud 256, a cable grommet 258, and a grommet nut 260. The bulkhead gasket 242 may be placed between the mounting fixture 110 and the base of the input mount 230. The bulkhead gasket 242 may provide a contact point and perform as a sealing surface between the ESP device 210 and the mounting fixture 110. The bulkhead gasket 242 may prevent water and dust from entering the housing 210 from the mounting fixture 110.

The panel nut 248 may have an internal threaded section for engaging the partially cylindrical surface 232. After the mounting fixture 110 is placed onto the input mounting port 231 of the input mount 230, the panel nut 248 may be applied to secure the mounting fixture 110 against the base of the input mount 230, or alternatively, against the bulkhead gasket 242. In one embodiment, for example, the panel nut 248 may be a standard M29 nut.

Because the locking surface 233 may prevent the housing 210 from rotating along the common axis A_{X}, the panel nut 248 may be conveniently engaged to the input mounting port 231 without having to manually stabilize the housing 210. That is, the locking surface 233 may cooperate with the cord segment 116 of the first mounting aperture 112 to provide a pivot point for the panel nut 248 during the engaging process. After the panel nut 248 is substantially engaged to the partially cylindrical surface 232 of the input mounting port 231, the input mount 230 may be pulled toward the mounting fixture 110. Consequentially, the input mount 230 may be mounted to the mounting fixture 110.

Optionally, the washer 246 may be placed in front of the mounting fixture 110 before the panel nut 248 mates with the input mounting port 231. The washer 246 may provide a stable surface for the panel nut 248, such that the force applied by the panel nut 248 may be distributed evenly around the first mounting aperture 112 of the mounting fixture 110. In one embodiment, for example, the washer 246 may be a standard M29 flat washer.

After the ESP device 200 is mounted to the mounting fixture 110, the Ethernet connector 202 may be inserted into the input mounting port 231 to establish a connection between the Ethernet cable 203 and the ESP device 200. In one embodiment, for example, the Ethernet connector 202 may be a standard RJ-45 connector. The input mount 230 may include an input interface port 234 to provide a mounting point for the connector shroud 256. The input interface port 234 may include a threaded cylindrical segment for engaging the connector shroud 256.

In one embodiment, the connector shroud gasket 252 may be inserted between the connector shroud 256 and the input mounting port 231. The connector shroud gasket 252 may serve as a sealing surface for the housing 210 and against the connector shroud 256. The cable grommet 258 may serve as a strain relief device for the connection end of the Ethernet cable 202. In one embodiment, for example, the cable grommet 258 may be an IP67 rated strain relief. The grommet nut 260 may be coupled to the connector shroud 256 to seal the cable grommet 258 within a space defined by the grommet nut 260 and the connector shroud 256. As a result, the grommet nut 260 may prevent water and dust from entering the housing 210 via the input interface port 234.

The output mounting port 221 may have a partially cylindrical surface 222 and a locking surface 223. The partially cylindrically surface 222 may be threaded, and it may be connected to the locking surface 223 to form a tube that has a D-shaped cross-section. The output mounting port 221 may serve at least two functions when the ESP device 200 is mounted externally. First, the output mounting port 221 may be used for receiving and protecting an Ethernet connector 202 and a portion of the Ethernet cable 203, which may be surge protected. Second, the output mounting port 221 may provide a mounting point such that the ESP device 200 may be mounted to the mounting fixture 110. Particularly, the D-shaped cross-section of the output mounting port 221 may match the shape of the first mounting aperture 112, so that the output mounting port 221 may penetrate the first mounting aperture 112.

The partially cylindrical surface 222 may have a similar curvature as an arc segment 113 of the first mounting aperture 112. After the output mounting port 221 is inserted through the first mounting aperture 112, the locking surface 223 may align with a cord segment 116 of the first mounting aperture 112. The locking surface 223 may be a flat surface, and it may cooperate with the cord segment 116 for preventing the housing 210 from rotating about the common axis A_{X}.

In one embodiment, the bulkhead gasket 242 may be placed between the mounting fixture 110 and the base of the output mount 220. The bulkhead gasket 242 may provide a contact point and perform as a sealing surface between the ESP device 210 and the mounting fixture 110. The bulkhead gasket 242 may prevent water and dust from entering the housing 210 from the mounting fixture 110.

The panel nut 248 may have an internal threaded section for engaging the partially cylindrical surface 222. After the mounting fixture 110 is placed onto the output mounting port 221 of the output mount 220, the panel nut 248 may be applied to secure the mounting fixture 110 against the base of the output mount 220, or alternatively, against the bulkhead gasket 242. Because the locking surface 223 may prevent the housing 210 from rotating along the common axis A_{X}, the panel nut 248 may be conveniently engaged to the output mounting port 221 without having to manually stabilize the housing 210.

That is, the locking surface 223 may cooperate with the cord segment 116 of the first mounting aperture 112 to provide a pivot point for the panel nut 248 during the engaging process. After the panel nut 248 is substantially engaged to the partially cylindrical surface 222 of the output mounting port 221, the output mount 220 may be pulled toward the mounting fixture 110. Consequentially, the output mount 220 may be mounted to the mounting fixture 110.

Optionally, the washer 246 may be placed in front of the mounting fixture 110 before the panel nut 248 mates with the output mounting port 221. The washer 246 may provide a stable surface for the panel nut 248, such that the force applied by the panel nut 248 may be distributed evenly around the first mounting aperture 112 of the mounting fixture 110.

After the ESP device 200 is mounted to the mounting fixture 110, the Ethernet connector 202 may be inserted into the output mounting port 221 to establish a connection between the Ethernet cable 203 and the ESP device 200. The output mount 220 may include an output interface port 224 to provide a mounting point for the connector shroud 256. The output interface port 224 may include a threaded cylindrical segment for engaging the connector shroud 256.

In one embodiment, the connector shroud gasket 252 may be inserted between the connector shroud 256 and the output mounting port 221. The connector shroud gasket 252 may serve as a sealing surface for the housing 210 and against the connector shroud 256. The cable grommet 258 may serve as a strain relief device for the connection end of the Ethernet cable 202. The grommet nut 260 may be coupled to the connector shroud 256 to seal the cable grommet 258 within a space defined by the grommet nut 260 and the connector shroud 256. As a result, the grommet nut 260 may prevent water and dust from entering the housing 210 via the output interface port 224.

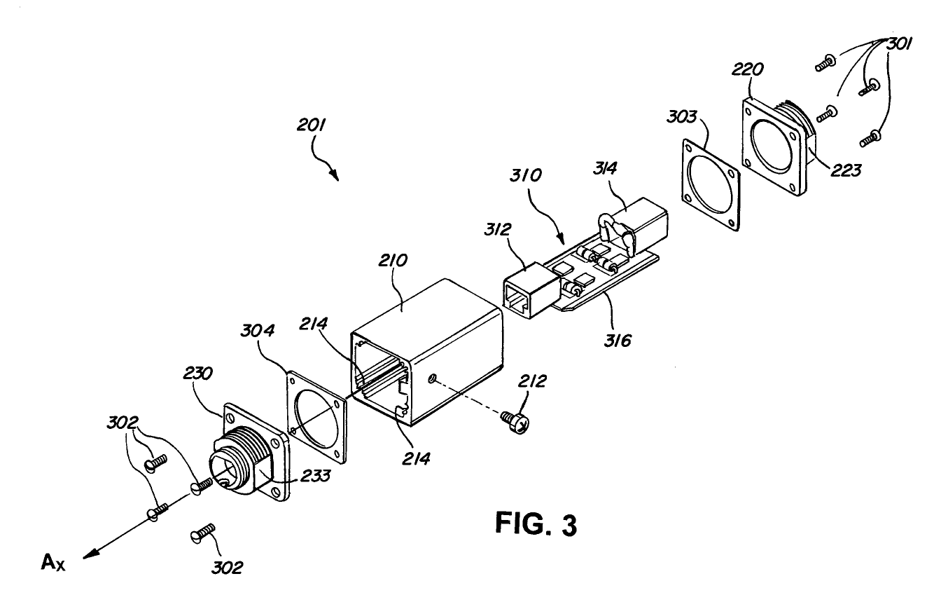

FIG. 3 shows an exploded perspective view of the ESP core member 201 according to an embodiment of the present invention. The ESP core member 201 may include a surge filter 310 for suppressing and/or filtering the surge component of the Ethernet signal. The surge filter 310 may include an Ethernet input port 312, various surge suppressing components 316, and an Ethernet output port 314. The Ethernet input port 312 may be used for receiving the Ethernet connector of an unprotected Ethernet cable, while the Ethernet output port 314 may be used for receiving the Ethernet connector of a protected Ethernet cable. In one embodiment, for example, each of the Ethernet input port 312 and the Ethernet output port 314 may be implemented by a standard RJ-45 connector port.

The various surge suppressing components 316 may be bonded to a printed circuit board or incorporated into a single chip set. The various surge suppressing components 316 may receive the unprotected Ethernet signal via the Ethernet input port 312. After suppressing the surge component of the Ethernet signal, the various surge suppressing components 316 may deliver the surge suppressed Ethernet signal via the Ethernet output port 314. The interior of the housing 210 may include one or more trenches 214 for receiving and aligning the surge filter 310. After the surge filter 310 is received and aligned within the space of the housing 210, the output mount 220 and the input mount 230 may enclose the housing 210. In one embodiment, for example, the output mount 220 may be secured to the housing 210 by applying a first set of screws 301, and the input mount 230 may be secured to the housing 210 by applying a second set of screws 302.

Optionally, the ESP core member 201 may include an output mount gasket 303 and an input mount gasket 304. The output mount gasket 303 may provide a stable interface and a sealing surface between the output mount 220 and the housing 210. The input mount gasket 304 may provide a stable interface and a sealing surface between the input mount 230 and the housing 210. Moreover, a ground lug 212 may be used for connecting the housing 210 to a ground source, such that the surge suppressing components 316 may have a reference ground. The ground lug 212 may be particularly helpful when the mounting fixture 110 is not connected to any ground source.

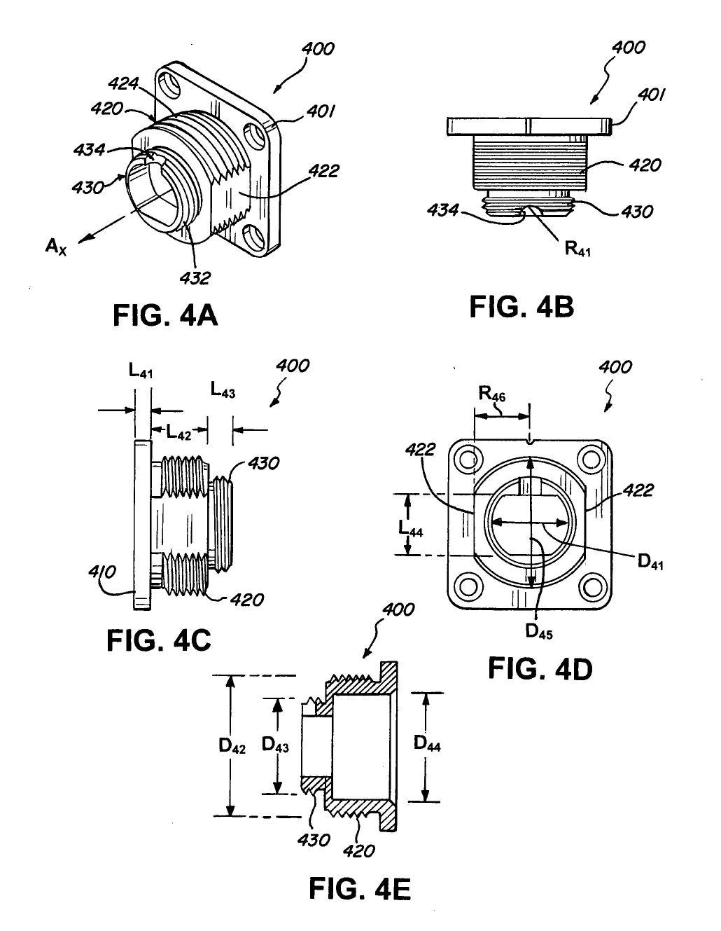

FIGS. 4A-4E show various dimensions of a bulkhead mount 400 according to various embodiments of the present invention. The bulkhead mount 400 is similar to the input mount 230 and the output mount 220 as shown in FIGS. 2-3. As such, the bulkhead mount 400 may be used at either end of the housing 210. Moreover, the bulkhead mount 400 may be adapted to ESP housings that have three or more openings. The bulkhead mount 400 may include an enclosure plate (or base member) 401, a bulkhead mounting port 420, and an interface port 430.

The enclosure plate 401 may be used for sealing one opening of the housing 210 or one opening of another ESP housing. The bulkhead mounting port 420 may become a mounting point for the housing 210 after the enclosure plate 401 is secured to the housing 210. The bulkhead mounting port 420 may have two flat locking surfaces 422 and two threaded engagement surfaces 424. The flat locking surfaces 422 may help stabilize the housing 210 once the bulkhead mounting port 420 is inserted into a mounting aperture of a bulkhead panel. The bulkhead panel may be preinstalled to a wall of a building, and it may be similar to the mounting fixture 110 as shown in FIGS. 1A-1B. Particularly, the flat locking surfaces 422 may prevent the housing 210 from rotating about the common axis A_{X}. Together, the flat locking surfaces 422 and the threaded engagement surfaces 424 may form a conduit that has a cross-section. In one embodiment, the cross-section may be defined by two arc segments and two cord segments. In another embodiment, the cross-section may be perpendicular to the common axis A_{X}.

The interface port 430 may include a threaded engagement surface 432 and a connector release notch 434. The threaded engagement surface 432 may be used for engaging one or more cable protection components, such as the connector shroud 256 as shown in FIGS. 2A-2B. The connector release notch 434 may provide an access point to the clipping member of the Ethernet connector 202. A user may decouple the Ethernet connector 202 from the Ethernet input port 312 or the Ethernet output port 314 by pressing against the clipping member of the Ethernet connector 202. Referring to FIG. 4B, the connector release notch 434 may be a semi-circular opening with a radius R₄₁. In one embodiment, for example, the radius R₄₁ may be about 0.098 inch.

Referring to FIG. 4C, which shows the side view of the bulkhead mount 400, the enclosure plate 401 may have a thickness L₄₁, the bulkhead mounting port 420 may have a thickness L₄₂, and the interface port 430 may have a thickness L₄₃. In one embodiment, for example, the thickness L₄₁ may be about 0.14 inch, the thickness L₄₂ may be about 0.47 inch, and the thickness L₄₃ may be about 0.22 inch.

Referring to FIG. 4D, which shows a front view of the bulkhead mount 400, the interface port 430 may have an interior height L₄₄ and an internal diameter D₄₁. In one embodiment, for example, the interior height L₄₄ may be about 0.449 inch and the interior diameter D₄₁ may be about 0.63 inch. The bulkhead mounting port 420 may have a cord radius R₄₆, which may be measured from the flat locking surface 422 to the center of the bulkhead mounting port 420. In one embodiment, for example, the cord radius R₄₆ may be about 0.488 inch. The bulkhead mounting port 420 may have an engagement diameter D₄₅, which may be the diameter of the threaded engagement surface 424. In one embodiment, for example, the engagement diameter D₄₅ may be about 0.483 inch.

Referring to FIG. 4E, which shows a cross-sectional side view of the bulkhead mount 400, the bulkhead mounting port 420 may have a threaded diameter D₄₂ and an interior diameter D₄₄. In one embodiment, for example, the threaded diameter D₄₂ may be about 2.9 cm and the interior diameter D₄₄ may be about 0.886 inch. The interface port 430 may have a threaded diameter D₄₃. In one embodiment, for example, the threaded diameter D₄₃ may be about 2 cm. The bulkhead mounting port 420 and the interface port 430 may have a similar inter-thread distance, which may be measured between the peaks of two adjacent threads. In one embodiment, for example, the inter-thread distance may be about 1.5 mm.

The bulkhead mounting port 420 may adopt various cross-sectional shapes. Although FIGS. 4A-4E show that the bulkhead mounting port 420 has two flat locking surfaces 422, the bulkhead mounting port 420 may have less than and/or more than two flat locking surfaces 422. The cross-section of the bulkhead mounting port 420 may be defined by the number of locking surfaces 422. For example, each of the locking surfaces 422 may form a cord segment of the cross-section, and each of the threaded engagement surface 424 may form an arc segment of the cross-section.

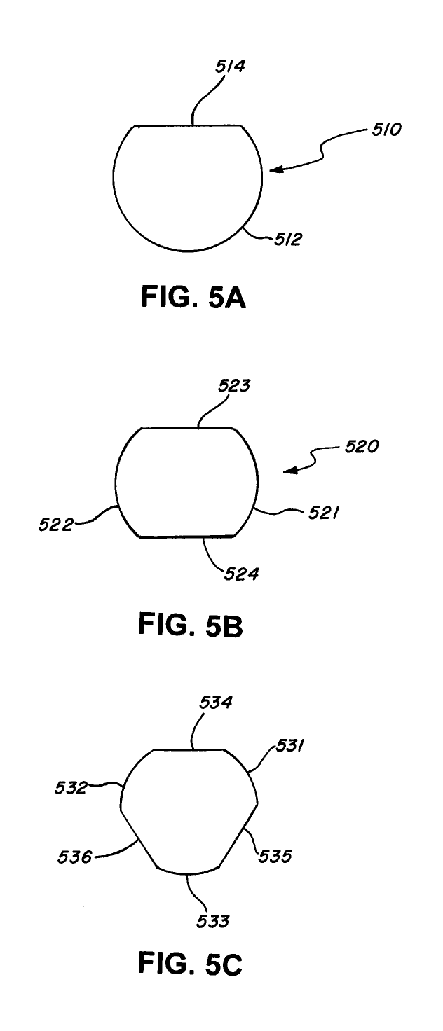

Referring to FIG. 5A, the bulkhead mounting port 420 may have a single-D cross-section 510. The single-D cross-section 510 may include a cord segment 514 and an arc segment 512. The cord segment 514 may be connected to the arc segment 512 to form a closed loop.

Referring to FIG. 5B, the bulkhead mounting port 420 may have a double-D cross-section 520. The double-D cross-section 520 may include a first cord segment 523, a second cord segment 524, a first arc segment 521, and a second arc segment 522. The first cord segment 523 may oppose the second cord segment 524. The first arc segment 521 may oppose the second arc segment 522. Each of the first cord segment 523 and the second cord segment 524 may be interposed between the first and second arc segments 521 and 522 to form a closed loop.

Referring to FIG. 5C, the bulkhead mounting port 420 may have a triple-D cross-section 530. The triple-D cross-section 530 may include a first cord segment 534, a second cord segment 535, a third cord segment 536, a first arc segment 531, a second arc segment 532, and a third arc segment 533. The first cord segment 534 may oppose the third arc segment 533. The second cord segment 535 may oppose the second arc segment 532. The third cord segment 536 may oppose the first arc segment 531. The first cord segment 534 the second cord segment 535, and the third cord segment 536 may be interposed among the first, second, and third arc segments 531, 532, and 533 to form a closed loop.

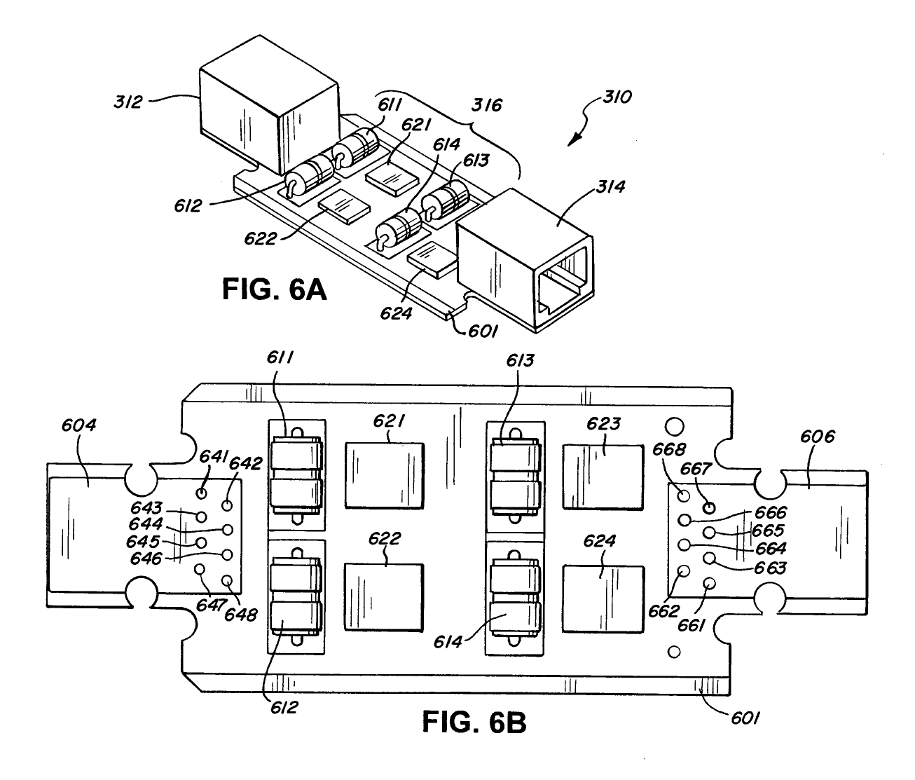

The discussion now turns to the structural and functional features of the surge filter. FIG. 6A shows a perspective view of the surge filter 310 according to an embodiment of the present invention. The surge filter 310 may include a printed circuit board (PCB) 601, a first voltage limiting device (VLD) 611, a second VLD 612, a third VLD 613, a fourth VLD 614, a first current limiting device (CLD) 621, a second CLD 622, a third CLD 623, and a fourth CLD 624. The first, second, third, and fourth VLDs 611, 612, 613, and 614 may be used for suppressing or filtering surge voltage introduced in an unprotected Ethernet signal. The first second, third, and fourth CLDs 621, 622, 623, and 624 may be used for suppressing or blocking surge current introduced in the unprotected Ethernet signal.

FIG. 6B shows a top view of the PCB 601 with various surge suppressing components according to an embodiment of the present invention. The PCB 601 may be a coplanar waveguide PCB with a plurality of coplanar signal traces. The PCB 601 may include an input port bonding pad 604 and an output port bonding pad 606. The input port bonding pad 604 may provide an area for receiving, aligning, and bonding the Ethernet input port 312. The input port bonding pad 604 may include a first input pin 641, a second input pin 642, a third input pin 643, a fourth input pin 644, a fifth input pin 645, a sixth input pin 646, a seventh input pin 647, and an eighth input pin 648. Once the Ethernet connector 202 of an unprotected Ethernet cable mates with the Ethernet input port 312, each of the first, second, third, fourth, fifth, sixth, seventh, and eighth input pins 641, 642, 643, 644, 645, 646, 647, and 648 may receive a multiplexed portion of an unprotected Ethernet signal from the unprotected Ethernet cable. Moreover, each of the first, second, third, fourth, fifth, sixth, seventh, and eighth input pins 641, 642, 643, 644, 645, 646, 647, and 648 may be connected to at least one signal trace of the PCB 601.

The output port bonding pad 606 may provide an area for receiving, aligning, and bonding the Ethernet output port 314. The output port bonding pad 606 may include a first output pin 661, a second output pin 662, a third output pin 663, a fourth output pin 664, a fifth output pin 665, a sixth output pin 666, a seventh output pin 667, and an eighth output pin 668. Once the Ethernet connector 202 of a protected Ethernet cable mates with the Ethernet output port 314, each of the first, second, third, fourth, fifth, sixth, seventh, and eighth output pins 661, 662, 663, 664, 665, 666, 667, and 668 may deliver a multiplexed portion of a protected Ethernet signal to the protected Ethernet cable. Moreover, each of the first, second, third, fourth, fifth, sixth, seventh, and eighth output pins 661, 662, 663, 664, 665, 666, 667, and 668 may be connected to at least one signal trace of the PCB 601. Accordingly, each of the first, second, third, fourth, fifth, sixth, seventh, and eighth output pins 661, 662, 663, 664, 665, 666, 667, and 668 may be, directly or indirectly, coupled with one of the first, second, third, fourth, fifth, sixth, seventh, and eighth input pins 641, 642, 643, 644, 645, 646, 647, and 648.

In one embodiment, the PCB 601 may include eight signal traces, each of which may be coupled between one input pin (e.g., the input pin 641, 642, 643, 644, 645, 646, 647, or 648) and a corresponding output pin (e.g., the output pin 661, 662, 663, 664, 665, 666, 667, or 668). Two signal traces may form a differential pair. As such, the PCB 601 may include four differential pairs. At least one VLD (e.g., the VLD 611, 612, 613, or 614) may be connected to one differential pair for suppressing or filtering the surge voltage contained therein. Optionally, at least one CLD (e.g., the CLD 621, 622, 623, or 624) may be connected to one differential pair for suppression or blocking the surge current contained therein.

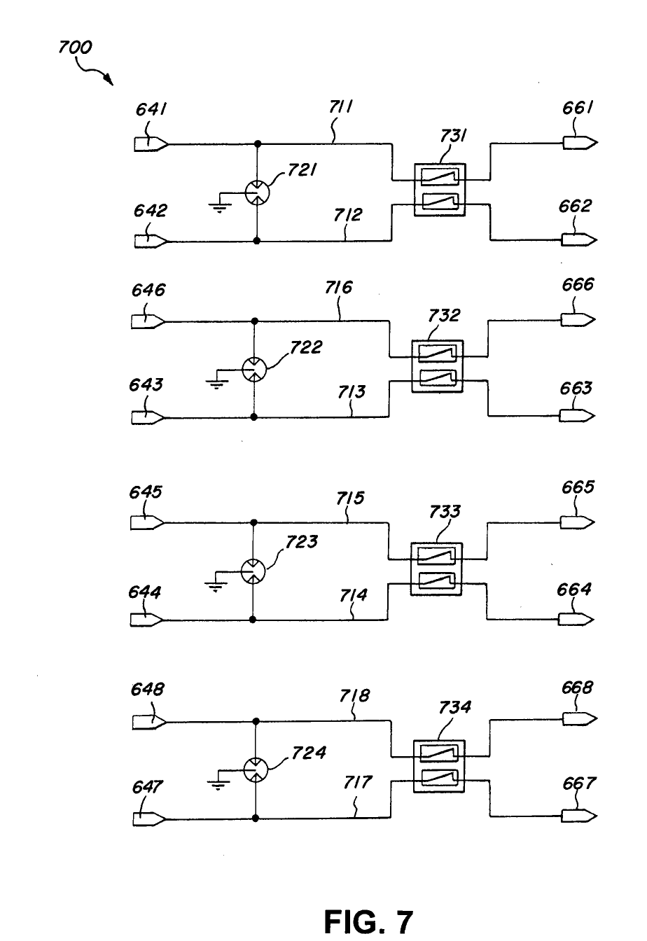

FIG. 7 shows a schematic view of a surge filter 700 for a high speed Ethernet signal according to an embodiment of the present invention. The surge filter 700 may be suitable for protecting Ethernet signals that have a transmission rate of about 1,000 megabits per second (e.g., a GigE signal). The surge filter 700 may include a plurality of gas discharge tubes (GDTs), which may be used as voltage limiting devices, and a plurality of transient blocking units (TBUs), which may be used as current limiting devices. Each GDT may suppress open surge voltages from 6,000 volts with a 2-ohm source impedance to about 35 volts with a 2-ohm source impedance. With 2-ohm source impedance, each TBU may block a surge current of about 3,000 ampere within a relatively short response time. When used in conjunction with each other, the GDT and TBU may suppress the surge voltage and surge current of the unprotected Ethernet signal.

In one embodiment, the surge filter 700 may include a first GDT 721, a second GDT 722, a third GDT 723, and a fourth GDT 724. The first GDT 721 may be coupled to a first signal trace 711 and a second signal trace 712, which may be arranged to form a first differential pair. As such the first GDT 721 may be used for suppressing or filtering surge voltage received from the first and second Ethernet input pins 641 and 642.

A second GDT 722 may be coupled to a sixth signal trace 716 and a third signal trace 713, which may be arranged to form a second differential pair. As such the second GDT 722 may be used for suppressing or filtering surge voltage received from the sixth and third Ethernet input pins 646 and 643.

A third GDT 723 may be coupled to a fifth signal trace 715 and a fourth signal trace 714, which may be arranged to form a third differential pair. As such the third GDT 723 may be used for suppressing or filtering surge voltage received from the fifth and fourth Ethernet input pins 645 and 644.

A fourth GDT 724 may be coupled to an eight signal trace 718 and a seventh signal trace 717, which may be arranged to form a fourth differential pair. As such the fourth GDT 724 may be used for suppressing or filtering surge voltage received from the eighth and seventh Ethernet input pins 641 and 642.

In one embodiment, the surge filter 700 may include a first TBU 731, a second TBU 732, a third TBU 733, and a fourth TBU 734. The first TBU 731 may be coupled to the first signal trace 711 and the second signal trace 712. By temporarily disconnecting the first signal trace 711 from the first Ethernet output pin 661, the first TBU 731 may prevent surge current from entering the first Ethernet output pin 661. Similarly, by temporarily disconnecting the second signal trace 712 from the second Ethernet output pin 662, the first TBU 731 may prevent surge current from entering the second Ethernet output pin 662.

The second TBU 732 may be coupled to the sixth signal trace 716 and the third signal trace 713. By temporarily disconnecting the sixth signal trace 716 from the sixth Ethernet output pin 666, the second TBU 732 may prevent surge current from entering the sixth Ethernet output pin 666. Similarly, by temporarily disconnecting the third signal trace 713 from the third Ethernet output pin 663, the second TBU 732 may prevent surge current from entering the third Ethernet output pin 663.

The third TBU 733 may be coupled to the fifth signal trace 715 and the fourth signal trace 714. By temporarily disconnecting the fifth signal trace 715 from the fifth Ethernet output pin 665, the third TBU 733 may prevent surge current from entering the fifth Ethernet output pin 665. Similarly, by temporarily disconnecting the fourth signal trace 714 from the fourth Ethernet output pin 664, the first TBU 733 may prevent surge current from entering the fourth Ethernet output pin 664.

The fourth TBU 734 may be coupled to the eighth signal trace 718 and the seventh signal trace 717. By temporarily disconnecting the eighth signal trace 718 from the eighth Ethernet output pin 668, the fourth TBU 734 may prevent surge current from entering the eighth Ethernet output pin 668. Similarly, by temporarily disconnecting the seventh signal trace 717 from the seventh Ethernet output pin 667, the fourth TBU 734 may prevent surge current from entering the seventh Ethernet output pin 667.

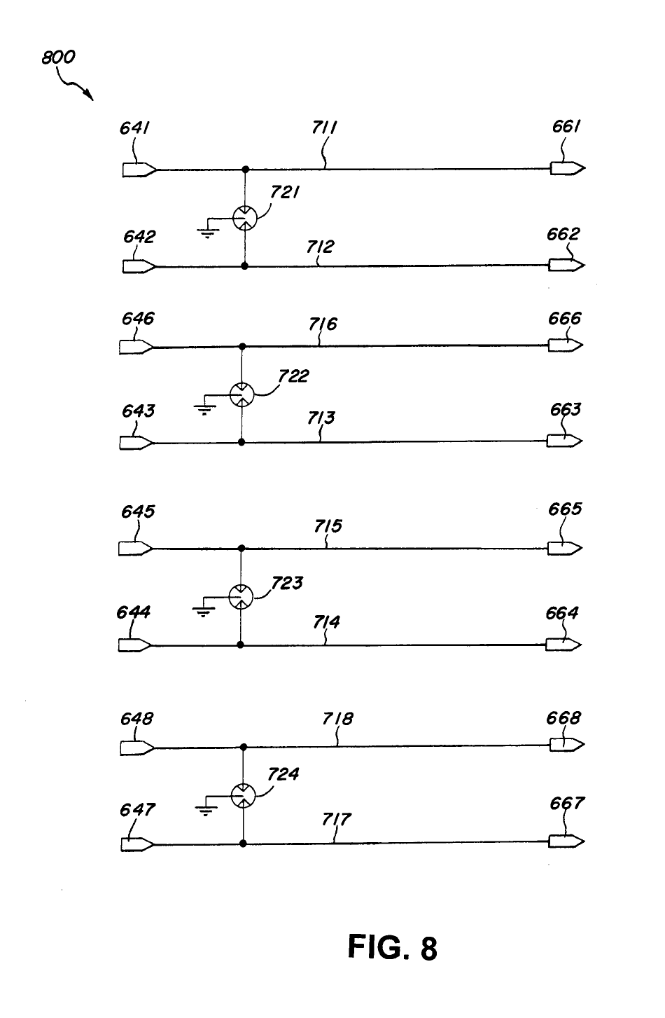

FIG. 8 shows a schematic view of a surge filter 800 for a high speed Ethernet signal with power transmission according to an embodiment of the present invention. The topology of the surge filter 800 can be similar to the topology of the surge filter 700 except that the signal traces (e.g., the signal traces 711, 712, 713, 714, 715, 716, 717, and 718) in the surge filter 800 may be used for transmitting data and power simultaneously. In one embodiment, for example, data may be transmitted at a rate of 1,000 megabits per second.

To ensure that the power transmission will not be interrupted, the current limiting devices (e.g., the TBUs 731, 732, 733, 734, 735, 736, 737, and 738) may be removed from the surge filter 800. As such, the signal traces (e.g., the signal traces 711, 712, 713, 714, 715, 716, 717, and 718) may establish eight direct connections between the input pins (e.g., input pins 641, 642, 643, 644, 645, 646, 647, and 648) and the corresponding output pins (e.g., input pins 661, 662, 663, 664, 665, 666, 667, and 668).

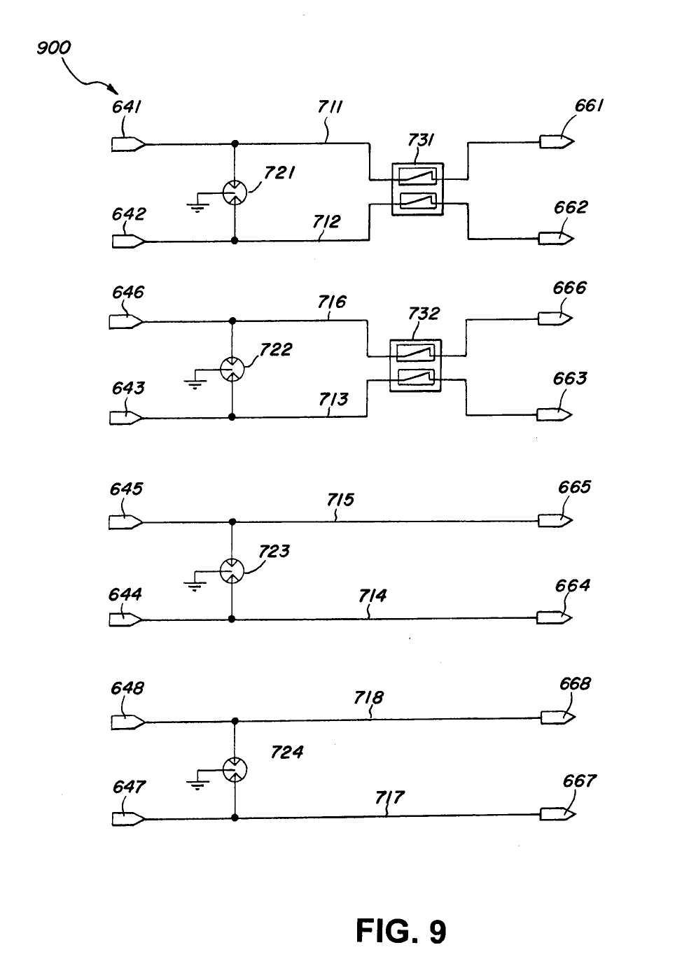

FIG. 9 shows a schematic view of a surge filter 900 for a POE signal according to an embodiment of the present invention. The topology of the surge filter 900 may be similar to the topologies of the surge filter 700 and the surge filter 800. Particularly, one half of the signal traces may be dedicated for power transmission while the other half of the signal traces may be dedicated for data transmission.

In one embodiment, for example, the first, second, sixth, and third signal traces 711, 712, 716, and 713 may be dedicated for transmitting data signal at a transmission rate of 100 megabits per second. As such, the first TBU 731 and the second TBU 732 may be used for blocking surge current from entering the first, second, sixth, and third output pins 661, 662, 666 and 663. In another embodiment, for example, the fifth, fourth, eighth, and seventh signal traces 715, 714, 718, and 717 may be dedicated for transmitting power. As such, the third TBU 733 and the fourth TBU 734 may be removed from the third and fourth differential pairs.

Each of the surge filters 700, 800, and 900 may handle high surge voltage and high surge current. Moreover, each of the surge filters 700, 800, and 900 may be used for suppressing both differential mode and common mode surge components. Optionally, a 100-ohm impedance device may be included for differential impedance matching, which may help reduce a signal reflection for the high speed Ethernet signal.

In one embodiment, coplanar waveguide technique may be used in forming the signal traces (e.g., the signal traces 711, 712, 713, 714, 715, 716, 717, and 718) on multiple layers of the PCB. Advantageously, the surge filter (e.g., the surge filters 700, 800, and/or 900) may have an improved differential signal quality, and the surge filter may be less susceptible to electromagnetic interference radiation, crosstalk among adjacent differential pairs, and common mode noise.

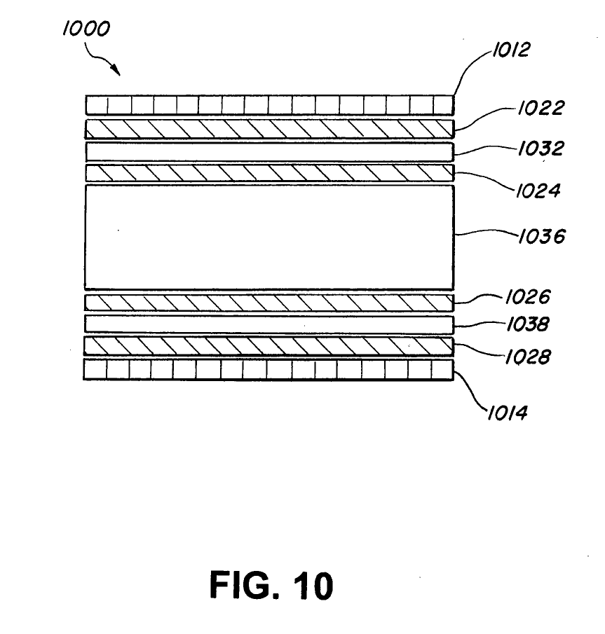

FIG. 10 shows a cross-sectional view of a coplanar waveguide printed circuit board (CWPCB) 1000 according to an embodiment of the present invention. The CWPCB 1000 may include a top mask layer 1012, a bottom mask layer 1014, a first signal trace layer 1022, a second signal trace layer 1024, a third signal trace layer 1026, a fourth signal trace layer 1028, a first dielectric layer 1032, a second dielectric layer 1038, and a core dielectric layer 1036.

The top mask layer 1012 and the bottom mask layer 1014 may be used for protecting the CWPCB 1000. In one embodiment, for example, each of the top mask layer 1012 and the bottom mask layer 1014 may have a thickness of about 0.0005 inch. The first dielectric layer 1032 may be used for separating the first signal trace layer 1022 and the second signal trace layer 1024. The second dielectric layer 1038 may be used for separating the third signal trace layer 1026 and the fourth signal trace layer 1028. In one embodiment, for example, each of the first and second dielectric layers 1032 and 1038 may have a relative permittivity of about 3.8 and a thickness of about 0.009 inch. The core dielectric layer 1036 may be used for separating the second signal trace layer 1024 and the third signal trace layer 1026. In one embodiment, for example, the core dielectric layer 1036 may have a relative permittivity of about 4.26 and a thickness of about 0.014 inch.

The first signal trace layer 1022 may include a first differential pair, such as the first and second signal traces 711 and 712 as shown in FIGS. 7-9. The second signal trace layer 1024 may include a second differential pair, such as the sixth and third signal traces 716 and 713. The third signal trace layer 1026 may include a third differential pair, such as the fifth and fourth signal traces 715 and 714. The fourth signal trace layer 1028 may include a fourth differential pair, such as the eighth and seventh signal traces 718 and 717. In one embodiment, for example, each of the first, second, third, and fourth signal trace layers 1022, 1024, 1026, and 1028 may be made of 2 ounces of copper and may have a thickness of about 0.0028 inch.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. An Ethernet surge protection (ESP) device, comprising:
a housing defining a space along an axis;
a threaded port configured to be coupled to the housing, and having a locking surface configured to prevent the housing from rotating about the axis upon engaging a mounting fixture; and
a surge filter disposed within the space, and configured to filter out a surge component of an Ethernet signal received from an input cable.

2. The ESP device of claim 1, wherein the threaded port is an input mount configured to receive the input cable for carrying the Ethernet signal.

3. The ESP device of claim 1, wherein the threaded port is an output mount configured to receive an output cable for carrying the filtered Ethernet signal.

4. The ESP device of claim 1, wherein the threaded port has a D-shaped cross-section perpendicular to the axis.

5. The ESP device of claim 1, wherein:
the threaded port includes a partially cylindrical surface, and
the locking surface is a flat surface arranged with the partially cylindrical surface to form a tube.

6. The ESP device of claim 1, wherein:
the threaded port includes a plurality of partially cylindrical surfaces, and
the locking surface includes a plurality of flat surfaces arranged with the plurality of partially cylindrical surfaces to form a tube.

7. The ESP device of claim 1, further comprising:
a nut configured to engage the threaded port and secure the housing to the mounting fixture.

8. The ESP device of claim 1, further comprising:
an interface port coupled to the threaded port, and having a cylindrical threaded surface; and
a connector shroud configured to engage the cylindrical threaded surface of the interface port and to protect a connector configured to be received by the threaded port.

9. The ESP device of claim 1, wherein the surge filter includes:
an input port configured to receive the Ethernet signal from the input cable,
a signal trace coupled to the input port, and configured to conduct the Ethernet signal,
a voltage limiting device coupled between the signal trace and a ground source, and configured to suppress a surge voltage of the surge component of the Ethernet signal, and
an output port coupled with the voltage limiting device, and configured to deliver the filtered Ethernet signal to an output cable.

10. The ESP device of claim 9, wherein the surge filter includes:
a current limiting device coupled to the signal trace, and configured to block a surge current of the surge component from reaching the output port.

11. An Ethernet surge protection (ESP) device, comprising:
a housing defining a cavity along an axis;
a plurality of threaded mounts, each of the plurality of threaded mounts detachably coupled to the housing, and having a locking surface configured to prevent the housing from rotating about the axis upon engaging a mounting fixture, the plurality of threaded mounts including an input threaded mount and an output threaded mount; and
a surge suppressor disposed within the cavity, the surge suppressor configured to suppress a surge component from an Ethernet signal received via the input threaded mount and deliver the surge suppressed Ethernet signal via the output threaded mount.

12. The ESP device of claim 11, wherein:
the surge suppressor includes an input port positioned within the input threaded mount, and
the input port configured to be coupled to an input cable for carrying the Ethernet signal.

13. The ESP device of claim 11, wherein:
the surge suppressor includes an output port positioned within the output threaded mount, and
the output port configured to be coupled to an output cable for receiving the surge suppressed Ethernet signal.

14. The ESP device of claim 11, wherein the input threaded mount and the output threaded mount each has a D-shaped cross-section perpendicular to the axis.

15. The ESP device of claim 11, wherein:
the threaded mount includes a partially cylindrical surface, and
the locking surface is a flat surface connected to the partially cylindrical surface to form a partially threaded tube.

16. The ESP device of claim 11, wherein:
the threaded mount includes a plurality of partially cylindrical surfaces, and
the locking surface includes a plurality of flat surfaces connected to the plurality of partially cylindrical surfaces to form a partially threaded tube.

17. The ESP device of claim 11, wherein the surge suppressor includes:
an input port configured to receive the Ethernet signal from an input cable received by the input threaded mount,
a signal trace coupled to the input port, and configured to conduct the Ethernet signal,
a voltage limiting device coupled between the signal trace and a ground source, and configured to suppress a surge voltage of the surge component of the Ethernet signal, and
an output port coupled with the voltage limiting device, and configured to deliver the surge suppressed Ethernet signal to an output cable received by the output threaded mount.

18. An Ethernet surge protection (ESP) device, comprising:
a housing defining a compartment along an axis;
a bulkhead mount configured to be coupled to the housing, and having a D-shaped cross-section perpendicular to the axis, the D-shaped cross-section including a threaded arc segment and a cord segment connecting the threaded arc segment, the threaded arc segment configured to receive a nut for securing the housing to a mounting fixture, the cord segment configured to cooperate with the mounting fixture to prevent the housing from rotating about the axis; and
a surge filter disposed within the compartment, and configured to filter out a surge component of an Ethernet signal received from an input cable.

19. The ESP device of claim 18, wherein the surge filter includes:
an input port configured to receive the Ethernet signal from the input cable,
a signal trace coupled to the input port, and configured to conduct the Ethernet signal,
a voltage limiting device coupled between the signal trace and a ground source, and configured to suppress a surge voltage of the surge component of the Ethernet signal, and
an output port coupled with the voltage limiting device, and configured to deliver the filtered Ethernet signal to an output cable.

20. The ESP device of claim 19, wherein the surge filter includes:
a current limiting device coupled to the signal trace, and configured to block a surge current of the surge component from reaching the output port.
